(19) United States
(12) Patent Application Publication
(10) Pub. No.: US 2011/0282811 A1
(43) Pub. Date: Nov. 17, 2011

(54) Method and Data Processing System for Automatic Identification, Processing, Interpretation and Evaluation of Objects in the Form of Digital Data, Especially Unknown Objects

(76) Inventor: Petra Perner, Leipzig (DE)

(21) Appl. No.: 12/523,730

(22) PCT Filed: Jan. 19, 2008
(86) PCT No.: PCT/DE2008/000094

§ 371 Date: Jul. 19, 2009

(30) Foreign Application Priority Data
Jan. 19, 2007 (DE) 10 2007 003 448.4

(51) Int. Cl. G06F 15/18

(52) U.S. Cl. 706/12

(57) ABSTRACT

The invention relates to methods and data processing systems for the automatic identification, processing, interpretation and evaluation of objects in the form of digital data, especially unknown objects. Said methods and systems are characterised in that objects which cannot be associated with any known model are entered into a case database as unknown objects. They are then available for automatic interpretation and evaluation by means of a similarity-based method. Said unknown objects can lead to new models. The model database is thereby continuously enlarged, existing models refined, and new models learned. The model data-base can be organised evenly or hierarchically in statistical models representing higher classes and lower classes.

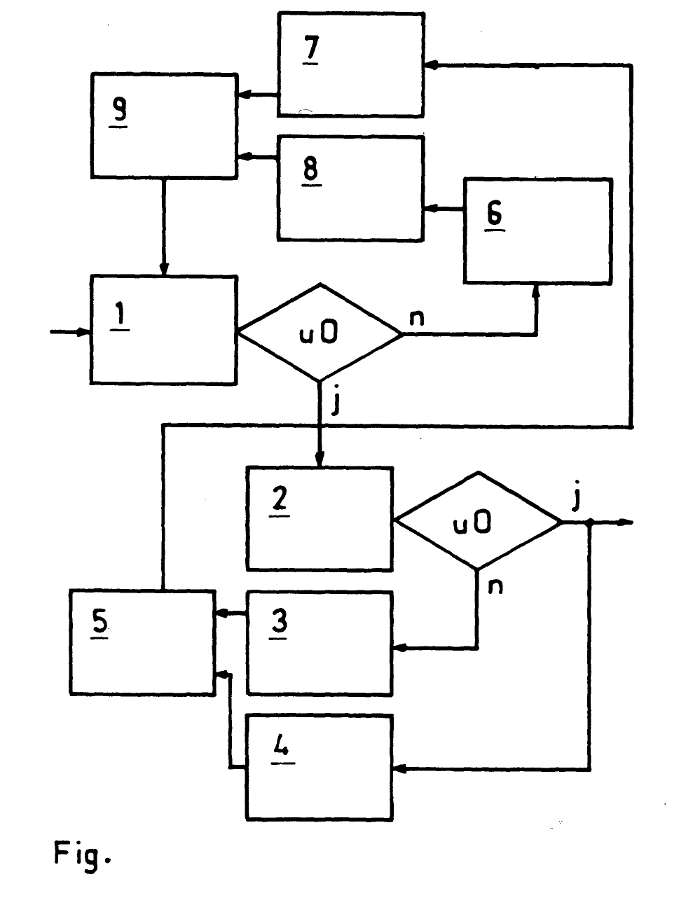

The invention concerns methods and data processing systems for automatic identification, processing, interpretation, and evaluation of objects in the form of digital data, in particular also of unknown objects, computer program products each comprising a program code for performing these methods, and computer program products on machine-readable carriers for performing these methods.

Arrangements for automatic examination of cells, cell complexes and other biological samples are disclosed inter alia in DE 196 16 997 A1 (Method for automatic microscope-supported examination of tissue samples or bodily fluid samples), DE 42 11 904 A1 (Method and device for producing a type list for a liquid sample), and DE 196 39 884 A1 (Pattern recognition system).

In DE 196 16 997 A1 tissue samples or bodily fluid samples are examined with respect to cell types through the application of neuronal networks. Smallest living beings such as worms, insects or snails are detected and identified in DE 42 11 904 A1. The identification is carried out by comparison with objects contained in a reference object memory. At the same time, the identified objects are counted and recorded in a type list.

In DE 196 39 884 A1 solid components are detected in a sample flow according to size, in particular in accordance with their projection length in the image along the x and the y axes, their circumference and their average color density.

A disadvantage is the lack of a possibility of automated processing.

DE 10 2004 018 174 (Method for acquisition of shapes of images with cases and case-based recognition of objects in digital images, computer program product, and digital memory medium for performing this method) methods for acquisition of shapes of images with cases and case-based recognition of objects in digital images, computer program products each with a program code for performing this method, computer program products on machine-readable carriers for performing this method, and digital memory media that can interact with the programmable computer system in such a way that these methods can be performed are known. The methods are characterized in particular in that the semi-automated individual shapes of cases in images are detected, that automatically, based on these individual shapes, abstract shape models of various abstraction levels are obtained and that automatically objects can be determined. The learned abstract shape models are either average shapes of groups of cases or medians as individual shapes of groups of cases. Unknown objects cannot be identified and interpreted automatically; evaluations of unknown objects cannot be done automatically.

The invention that is disdosed in claims 1, 8, 11, and 12 has the object to automatically identify objects present in the form of digital data, to determine them, correlate them, interpret them and to evaluate them.

This object is solved by the features listed in claims 1, 8, 11 and 12.

The methods and data processing systems for automated identification, processing, interpretation and evaluation of objects present as digital data, in particular also of unknown objects, is characterized in particular in that the objects that cannot be assigned to any known model, are identified as unknown objects and recorded in a case database. Accordingly, they are available for automated interpretation and evaluation by means of a similarity-based method. These unknown objects can lead to new models. In this way, a constant expansion of the model database is provided wherein already existing models are improved and new models can be learned. For this purpose, by means of a decision module based on 1 to n models of a model database, it is decided according to the Bayes decision criterion whether the new object can be assigned to a known model class. For no unknown object, the unknown object is assigned as a new object to a model class and saved in a cache. In case of an unknown object, by means of a module of a similarity-based evaluation the unknown object is compared with objects saved in a case database.

In case of a positive comparison result, the unknown object is assigned to a case class with similar or same objects. In case of a negative comparison result, the unknown object is marked as not being correlated with any model class and is either assigned to a case class or a new case class. The model database can be organized as a flat one or a hierarchical one in static models that represent superclasses and subclasses (specializations).

Moreover, the objects of a case class of the case database are processed in a MML learning module (MML—minimum message length) or MDL learning module (MDL—minimum description length) for models, connected to the case database, such that the objects of the case class either are assigned to the model class in the model database or are saved in the model database as a new model class including a new model wherein the entry of the class in the case database is deleted. At the same time, the data for the new model are also saved in a cache as a model class.

By means of the methods and data processing systems it is thus possible to automatically identify, determine and assign a variety of objects. Moreover, evaluations based on the objects are possible that lead to new classes and based thereon to new model classes with one model each. Accordingly, it is also possible to conclude an event as a result of the cause.

A further advantage resides in that the objects present as digital data can be of very varied kinds and are represented as characteristic value pairs. Such objects are inter alia letter combinations, words, signs and images, each individual, in at least one combination or as a series. By means of the Bayes decision criterion it is decided whether a known or an unknown object is present, wherein the known object is assigned to a model and thus to a model class. A further advantage resides in that these models of the objects of the model class are updated and thus adjusted. The Bayes decision criterion can be based preferably on a Dirichlet distribution or a standard distribution.

Unknown objects are assigned by means of the module of similarity-based evaluation to case classes or new case classes that form new model classes and thus models.

The objects are advantageously added unchanged.

Accordingly, the methods and data processing systems are suitable for most varied objects with very different applications. These are inter alia in medicine the generation of a diagnosis based on the object, in computer sciences a correlation (for example, e-mail is spam), in quality management the validity of test series as well as the identification, determination and also tracking of visually detected objects, each with the possibilities of evaluations based on these objects. In addition to assignment of objects to existing model classes, the objects that cannot be assigned are assigned to case classes with objects or new case dasses. The structure of the system remains intact in this connection. At the same time it is ensured that the employed model is updated when new objects are added.

The methods can be made available to the users advantageously as computer program products each with a program code for performing the methods for automatic identification, processing, interpretation and evaluation of objects present as digital data and as computer program products on machine-readable carriers for performing the methods for automatic identification, processing, interpretation, and evaluation of objects present as digital data.

Advantageous embodiments of the invention are disclosed in claims 2 to 8 and 10.

The objects of a model class according to the embodiment of claim 2 are processed by means of an MML updating module for an MDL updating module in such a way that the respective model of the model class is updated. In this way, the model can be matched to reality by means of the objects of the model class. A further advantage resides in that a change of the reality also effects a change of the model of the model class.

According to the embodiment of claim 3, by means of the MML updating module or the MDL updating module the parameters of a distribution density function are newly learned for a certain number of objects of a model class of a cache. In this way the model of the model class is updated. A constant update is avoided and updating times are limited.

According to the embodiment of claim 4, models are advantageously learned based on known objects.

According to the embodiment of claim 5, models are advantageously learned based on known objects wherein a feature selection of the objects is carried out as a prerequisite for the Bayes decision criterion.

The module of a similarity-based evaluation is based according to the embodiment of claim 6 on the fuzzy similarity in order to model the uncertainty of the data.

By means of a determination module upstream of the module of a similarity-based evaluation, according to the embodiment of claim 7, objects that represent outliers are identified and they are assigned to a case class or a new case class. Moreover, the number and similarity of outliers are the basis for a new model class.

In the data processing system according to the embodiment of claim 9 the case database is organized hierarchically in case classes wherein similar objects and their frequency in the case classes are the basis for learning new statistical model classes so that new strategies for learning news statistic model classes are determined.

According to the embodiment of claim 10, the objects are signs, images of objects, feature descriptions of objects, property descriptions of objects, sequences of objects, feature descriptions, property descriptions, and patterns of objects, each individually or in at least one combination.

Objects are, for example, seeds and grains.

Advantageously, in this way particularly the quality of seeds or grains can be determined. This includes also cereals. Seeds or grains that are infected by a disease or damaged but also parts thereof can be detected automatically. Quality defects such as inter alia caused by split-open grains, grain outgrowth, laterally incomplete husk formation, husk-damaged grains, twin growth, green grains, intact red grains, damaged red grains, and oat grass can be detected. Of course, also the intact grains of the sample are determined. This also includes their size. In this way, an objective determination of the proportion of intact and defective seeds or grains can be realized.

Detectable fungus-damaged grains represent impairments with regard to the processing value as well as with regard to hygienic considerations and therefore do not belong to flawless basic cereals. Fungus-damaged components generally are considered risky material as a result of the unpleasant odor and taste and the high total number of germs with simultaneous high mycotoxin potential. They are unsuitable for the production of hygienically proper food and feed material. In particular for consumer protection the detection of fungus-damaged grains is therefore of great importance.

The microflora of grains includes toxinogenic species as well as species that are detrimental with regard to consumption value and processing value. The symptoms partially cannot be macroscopically differentiated from the toxin-forming species. An additional identification of the fungus species by means of the characteristic spore shapes is a particular advantage.

Moreover, changes in the damage caused by changing environmental conditions can be identified and assigned automatically as unknown objects (novelty detection).

Further objects are, for example, cells or cell sections. In particular, diseases or their courses across certain cell developments can be evaluated. By means of the determination of the state of cells directly, or by means of cell sections, for example in the form of Hep-2 cell sections, diseases and their courses can be determined and their course can be followed.

Moreover, the presence, the number and possible development of microorganisms, fungal spores or pollen as biotic particles can be detected and determined advantageously as objects.

Further applications are in meteorology and climate research. In particular in regard to weather forecasting with respect to changing climates or thunderstorm risks there are advantageous applications. In this way, in particular based on records and actual measured data, for example, of the temperature, wind velocity, and moisture as attribute value pairs, forecasts can be derived. For climate research particularly drill cores are employed. In case of drill cores, easily the layer sequence can be the object or components of the drill core, for example, pollen, can be the object. Based on the presence and the types of pollen, conclusions with regard to the past climate can be derived easily. Moreover, based thereon also forecasts of climate changes to be expected can be derived.

The data of the images of objects can be, for example, also derived from at least one detector that forms an image of the at least one object. The detector is connected to the data processing system in such a way that the image of the object is received in the evaluation module in the data processing system as an object that is true to color, color-coded, or converted to grayscale. The imaging detector can advantageously be a component of an optical spectrometer or of an imaging device.

Further objects can also be objects in databases. These are inter alia telecommunication data, presentation data, images, illustrations or signs of various kinds.

The aforementioned objects can be, individually or in at least one combination, objects of the method for automatic identification, processing, interpretation and evaluation of objects that are present as digital data, particularly also of unknown objects.

One embodiment of the invention is shown schematically in the drawing and will be explained in the following in more detail.

It is shown in the:

FIGURE a data processing system for performing a method for automatic identification, processing, interpretation and evaluation of objects present as digital data.

In the following first embodiment a method and a data processing system for automatic identification, processing, interpretation and evaluation of objects present as digital data will be explained together in more detail.

A data processing system for performing the method for automatic identification, processing, interpretation and evaluation of objects present as digital data is comprised substantially of a data processing device comprising a decision module 1, a module 2 for similarity-based evaluation, an update module 3 for case classes, a control module 4 for case classes, an MML updating module 8 or an MDL updating module, an MML learning module 7 or an MDL learning module, a model database 9, a cache 6 and a case database 5. These elements are all components of the data processing system.

The FIGURE shows a data processing system for performing a method for automatic identification, processing, interpretation and evaluation of objects present as digital data in a schematic illustration.

In the FIGURE the decisions yes is shown at j and no is shown at n.

By means of the decision module 1, based on the 1 to n models of a model database 9, for a new object it is decided according to Bayes decision criterion whether the new object can be assigned to a known model class. Models can be learned based on known objects wherein a feature selection of the objects can be performed is a prerequisite for the Bayes decision criterion. The Bayes decision criterion is based on the Dirichlet distribution or standard distribution.

For no unknown object (uO) the object is saved, assigned as a new object to a model class, in a cache 6 that is connected to the decision module 1.

For an unknown object (uO) by means of a module 2 of a similarity-based evaluation that is connected to the decision module 1, the new unknown object (uO) is compared to the objects saved in a case database 5. In case of positive comparison result, the unknown object (uO) is assigned to a case class with similar or same objects. This is done by an update module 3 between the module 2 of a similarity-based evaluation and the case database 5. This module 2 is based on the fuzzy similarity in order to model the uncertainty of the data.

In case of a negative comparison result, the unknown object (uO) is indicated by means of a control module 4 that is connected between the module 2 of a similarity-based evaluation and the case database 5 as not belonging to a model class and is either assigned to a case class or to a new case class.

The case database 5 itself is hierarchically ordered with respect to classes, wherein similar objects and their frequency are ordered in the case classes, wherein similar objects and their frequency in the case classes are the basis for learning new statistical model classes so that new strategies for learning new statistical model classes are determined.

The hierarchically ordered database ensures that data are hierarchically collected in supergroups and/or subgroups. As long as there are not sufficient cases for subgroups, the data can be retrieved and used for learning a coarse statistical model. At the time when sufficient data for the subgroups are present, a special statistical model for the data can be learned. The coarse statistical model, in the case of a flat representation of the models, is eliminated or it represents the super node in the hierarchic statistical model.

Moreover, the objects of a case class of the case database 5 are processed for models by means of an MML learning module 7 (MML—minimum message length) or an MDL learning module (MDL—minimum description length) that are connected between the case database 5 and the model database 9 in such a way that the objects of the case class are either assigned to a model class in the model database 9 or are saved as a new model class including a new module in the model database 9. The entry of the class in the case database 5 is deleted. At the same time, the data for the new model are saved also in a cache 6 as a model class. Moreover, the objects of a model class in the cache 6 are processed by means of an MML updating module 8 or an MDL updating module in such a way that the respective model is updated. For this purpose, the MML updating module 8 or the MDL updating module is connected between the cache 6 and the model database 9. For a certain number of objects of a model class of a cache 6 by means of the MML updating module 8 or the MDL updating module the parameters of the distribution density function are learned anew and thus the model of the model class is updated.

In one embodiment, a determination module for unknown objects can be connected between the decision module 1 and the module 2 of a similarity-based evaluation. In this way, objects that represent outliers can be identified and can be assigned to a case class or a new case class. The number and similarity of outliers are the basis for a new model class.

A second embodiment is represented by a computer program product with a program code for performing a method described in the first embodiment for automatic identification, processing, interpretation and evaluation of objects present as digital data, when the program is running on a computer.

A third embodiment is a computer program product on a machine-readable carrier for performing a method disclosed in the first embodiment for automatic identification, processing, interpretation, and evaluation of objects present as digital data, when the program is running on a computer.

What is claimed is:

1. Method for automatic identification, processing, interpretation and evaluation of objects in the form of digital data, especially also of unknown objects, characterized in that by means of a decision module (1) based on 1 to n models of a model database (9) according to Bayes decision criterion it is determined whether the object can be assigned to a known model class, in that, in case of no unknown object, the object is saved, assigned as a new object to a model class, in a cache (6), in that in case of an unknown object by means of a module (2) of a similarity-based evaluation the unknown object is compared to objects saved in a case database (5), in that in case of a positive comparison result the unknown object is assigned to a case class with similar or same objects, in that in case of a negative comparison result the unknown object is indicated as not belonging to a model class and is assigned either to a case class or a new case class, in that the objects of a case class of the case database (5) are processed in an MML learning module (7) (MML minimum message length) or in an MDL learning module (MDL minimum description length) for models, connected to the case database, in such a way that the objects of the case class are assigned either to a model class in the model database (9) or are saved in the model database (9) as a new model class including a new model and the entry of the class in the case database (5) is deleted, and in that the data for the new model are saved also in a cache (6) as a model class.

2. Method according to claim 1, characterized in that the objects of a model class are processed by an MML updating module (8) or an MDL updating module such that the respective model of the model class is updated.

3. Method according to claim 1, characterized in that for a certain number of objects of a model class of a cache (6) by means of either the MML updating module (8) or the MDL updating module the parameters of a distribution density function are learned anew and the model of the model class is updated accordingly.

4. Method according to claim 1, characterized in that the models are learned based on known objects.

5. Method according to claim 1, characterized in that models are learned based on known objects, wherein a feature selection of the objects is performed as a prerequisite for the Bayes decision criterion.

6. Method according to claim 1, characterized in that the module (2) of a similarity-based evaluation is based preferably on fussy similarity in order to model the uncertainty of the data.

7. Method according to claim 1, characterized in that by means of the determination module upstream of the module (2) of a similarity-based evaluation objects representing outliers are recognized and are assigned to a case class or to a new case class and in that the number and the similarity of outliers is the basis for a new model class.

8. Data processing system for performing the method according to claim 1, characterized in that in the data processing system a decision module (1) and a model database (9) are connected to one another so that, based on the 1 to n models of the model database (9) according to Bayes decision criterion it is determined whether the new object is to be assigned to a known dass, in that the decision module (1) is connected with a cache (6) each for a model class such that no unknown object of the model class is saved in the corresponding cache (6), in that the decision module (1) is connected to a module (2) of a similarity-based evaluation for an unknown object, wherein the unknown object is compared to objects saved in a case database (5), so that, in case of a positive comparison result, the unknown object of a case class with similar or same objects or in case of a negative comparison result the unknown object is indicated as not belonging to a model class and is assigned either to a case class or a new case class, in that the case database (5) is connected by either an MML learning module (7) (MML—minimum message length) or an MDL learning module (MDL—minimum description length) to the model database (9) in such a way that the objects of the case class are assigned either to a model class in the model database (9) or are saved in the model database (9) as a new model class including a new model and the entry of the new case class in the case database (5) is deleted.

9. Data processing system according to claim 8, characterized in that in the data processing system the case database (5) is ordered hierarchically in case classes wherein similar objects and their frequency in the case classes are the basis for learning new statistical model classes and/or ensure a strategy model that in case of the presence of sufficient objects in a case class these data are transferred for learning a new statistical model to a statistic learning module so that new strategies for learning new statistical model classes are determined.

10. Data processing system according to claim 8, characterized in that objets are signs, illustrations of objects, feature descriptions of objects, property descriptions of objects, sequences of objects, feature descriptions and property descriptions, and patterns of objects, each individually or in at least one combination.

11. Computer program product with a program code for performing the method for automatic identification, processing, interpretation and evaluation of objects in the form of digital data, especially also of unknown objects, according to claim 1, when the program is running on a computer.

12. Computer program product on a machine-readable carrier for performing the method for autom atic identification, processing, interpretation and evaluation of objects in the form of digital data, especially also of unknown objects, according to claim 1, when the program is running on a computer
